(19) United States
(12) Patent Application Publication
(10) Pub. No.: US 2025/0196645 A1
(43) Pub. Date: Jun. 19, 2025

(54) ELECTRIC VEHICLE HAVING ONBOARD ELECTRICAL OUTLET

(71) Applicant: GM GLOBAL TECHNOLOGY OPERATIONS LLC, DETROIT, MI (US)

(72) Inventors: Samantha Gunter Miller, Berkley, MI (US); Charles J. Swan, Farmington Hills, MI (US); Firas Shabo, Shelby Township, MI (US); Vijay A. Neelakantan, Rochester Hills, MI (US)

(21) Appl. No.: 18/539,630

(22) Filed: Dec. 14, 2023

(51) Int. Cl. B60L 1/00; B60L 50/60; B60L 53/16; B60L 53/20; B60R 16/033

(52) U.S. Cl. CPC B60L 1/006; B60L 50/60; B60L 53/16; B60L 53/20; B60R 16/033

(57) ABSTRACT

An electric vehicle having a charge port, a first onboard electrical outlet, and a split-phase onboard electrical outlet is provided. The electric vehicle also includes a high-voltage battery, a primary onboard charging module electrically connected to the high-voltage battery, and a secondary onboard charging module electrically connected to the high-voltage battery and to the split-phase onboard electrical outlet. The electric vehicle further includes a diverter electrically connected to the primary onboard charging module, the diverter configured to selectively connect the primary onboard charging module to the charge port or to the first onboard electrical outlet and the split-phase onboard electrical outlet and a controller configured to control an operation of the diverter. The primary onboard charging module and the secondary onboard charging module each include a bidirectional alternating current (AC) to direct current (DC) converter.

### INTRODUCTION

The disclosure relates to electric vehicles. More specifically, the disclosure relates to an electric vehicle having one or more onboard electrical outlets.

It is often desired for a vehicle to include an onboard electrical outlet, such as a one hundred and twenty volt alternating current outlet. In order to provide power to onboard electrical outlets, vehicles are often equipped with a dedicated direct-current to alternating-current converter to provide power to the onboard electrical outlet.

### SUMMARY

In one exemplary embodiment, an electric vehicle having a charge port, an onboard electrical outlet, and a high-voltage battery is provided. The electric vehicle also includes a primary onboard charging module electrically connected to the high-voltage battery, a diverter configured to selectively connect the primary onboard charging module to one of the onboard electrical outlet and the charge port, and a controller configured to control an operation of the diverter. The primary onboard charging module includes a bidirectional alternating current (AC) to direct current (DC) converter.

In addition to the one or more features described herein the electric vehicle also includes a secondary onboard charging module electrically connected to the high-voltage battery and a split-phase onboard electrical outlet electrically connected to the secondary onboard charging module and the diverter, where the secondary onboard charging module includes a DC to AC converter.

In addition to the one or more features described herein the onboard electrical outlet is electrically connected to the split-phase onboard electrical outlet.

In addition to the one or more features described herein the split-phase onboard electrical outlet has an output voltage that is twice the output voltage of the onboard electrical outlet.

In addition to the one or more features described herein an AC output of the secondary onboard charging module is configured to be one hundred and eighty degrees out of phase with an AC output of the primary onboard charging module.

In addition to the one or more features described herein the controller is further configured to control an operation of the primary onboard charging module and the secondary onboard charging module.

In addition to the one or more features described herein the electric vehicle also includes a circuit breaker disposed between the diverter and the onboard electrical outlet.

In one exemplary embodiment, an electric vehicle having a charge port, an onboard electrical outlet, a split-phase onboard electrical outlet, and a high-voltage battery is provided. The electric vehicle also includes a primary onboard charging module electrically connected to the high-voltage battery and a secondary onboard charging module electrically connected to the high-voltage battery and to the split-phase onboard electrical outlet. The electric vehicle further includes a diverter electrically connected to the primary onboard charging module, the diverter configured to selectively connect the primary onboard charging module to the charge port or to the onboard electrical outlet and the split-phase onboard electrical outlet and a controller configured to control an operation of the diverter. The primary onboard charging module and the secondary onboard charging module each include a bidirectional alternating current (AC) to direct current (DC) converter.

In addition to the one or more features described herein the split-phase onboard electrical outlet has an output voltage that is twice the output voltage of the onboard electrical outlet.

In addition to the one or more features described herein an AC output of the secondary onboard charging module is configured to be one hundred and eighty degrees out of phase with an AC output of the primary onboard charging module.

In addition to the one or more features described herein the controller is further configured to control an operation of the primary onboard charging module and the secondary onboard charging module.

In addition to the one or more features described herein the electric vehicle also includes circuit breakers disposed between: the diverter and the onboard electrical outlet; the diverter and the split-phase onboard electrical outlet; the secondary onboard charging module and the onboard electrical outlet; and the secondary onboard charging module and the split-phase onboard electrical outlet.

In addition to the one or more features described herein the circuit breakers are electronically controlled circuit breakers that are operated by the controller.

In addition to the one or more features described herein the primary onboard charging module is configured to communicate directly with the secondary onboard charging module.

In addition to the one or more features described herein the onboard electrical outlet and the split-phase onboard electrical outlet include an indicator light that indicates whether the onboard electrical outlet and the split-phase onboard electrical outlet are energized.

In addition to the one or more features described herein the diverter is further configured to selectively connect the charge port to the secondary onboard charging module.

In one exemplary embodiment, an electric vehicle having a charge port, a first onboard electrical outlet, a second onboard electrical outlet, a split-phase onboard electrical outlet, and a high-voltage battery is provided. The electric vehicle also includes a primary onboard charging module electrically connected to the high-voltage battery and a secondary onboard charging module electrically connected to the high-voltage battery, to the second onboard electrical outlet, and to the split-phase onboard electrical outlet. The electric vehicle further includes a diverter electrically connected to the primary onboard charging module, the diverter configured to selectively connect the primary onboard charging module to the charge port or to the first onboard electrical outlet and the split-phase onboard electrical outlet and a controller configured to control an operation of the diverter. The primary onboard charging module and the secondary onboard charging module each include a bidirectional alternating current (AC) to direct current (DC) converter.

In addition to the one or more features described herein the split-phase onboard electrical outlet has an output voltage that is twice the output voltage of the first onboard electrical outlet and the second onboard electrical outlet.

In addition to the one or more features described herein an AC output of the secondary onboard charging module is configured to be one hundred and eighty degrees out of phase with an AC output of the primary onboard charging module.

In addition to the one or more features described herein the controller is further configured to control an operation of the primary onboard charging module and the secondary onboard charging module.

The above features and advantages, and other features and advantages of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 is a schematic diagram of an electric vehicle in accordance with an exemplary embodiment;

FIG. 2 is a block diagram illustrating a portion of an electrical system of a traditional electric vehicle;

FIG. 3 is a block diagram illustrating a portion of the electrical system of an electric vehicle in accordance with an exemplary embodiment;

FIG. 4 is a block diagram illustrating a portion of the electrical system of an electric vehicle in accordance with an exemplary embodiment;

FIG. 5 is a block diagram illustrating a portion of the electrical system of an electric vehicle in accordance with an exemplary embodiment;

FIG. 6 is a block diagram illustrating a portion of the electrical system of an electric vehicle in accordance with an exemplary embodiment;

FIG. 7 is a block diagram illustrating a portion of the electrical system of an electric vehicle in accordance with an exemplary embodiment; and

FIG. 8 is a block diagram illustrating a portion of the electrical system of an electric vehicle in accordance with an exemplary embodiment.

### DETAILED DESCRIPTION

The following description is merely exemplary in nature and is not intended to limit the present disclosure, its application or uses. Various embodiments of the disclosure are described herein with reference to the related drawings. Alternative embodiments of the disclosure can be devised without departing from the scope of the claims. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship.

As discussed herein, in order to provide power to onboard electrical outlets, vehicles are often equipped with a dedicated direct-current to alternating-current converter to provide power to the onboard electrical outlet. Electric vehicles include onboard charging modules that are configured to convert an alternating current received from a charge port to a direct current that is used to charge a high-voltage battery. Embodiments of the disclosure are directed to electric vehicles that include a diverter that is configured to selectively connect an onboard charging module to one of the charging port and an onboard electrical outlet.

In exemplary embodiments, an electric vehicle having a charge port for receiving an alternating current to charge the electric vehicle is provided. The electric vehicle includes a primary onboard charging module that is electrically connected to the high-voltage battery and that includes a bi-directional alternating current to direct current converter. The electric vehicle also includes a diverter that is configured to selectively connect the primary onboard charging module to one of the charge port and an onboard electrical outlet. In exemplary embodiments, the electric vehicle includes a controller that is configured to control the operation of the diverter. During charging of the electric vehicle, the diverter is configured to connect the primary onboard charging module to the charge port and when the electric vehicle is not transferring energy to or from the charge port the diverter is configured to connect the primary onboard charging module to the onboard charging port.

In exemplary embodiments, the electric vehicle also includes a secondary onboard charging module that is electrically connected to the high-voltage battery. The secondary onboard charging module includes a direct current to alternating current converter. The electric vehicle also includes a split-phase onboard electrical outlet electrically connected to the secondary onboard charging module and the diverter. The split-phase onboard electrical outlet has an output voltage that is twice the output voltage of the onboard electrical outlet. For example, the single-phase onboard electrical outlet may have an output of approximately one hundred twenty volts, and the split-phase onboard electrical outlet may have an output of approximately one hundred twenty volts and two hundred forty volts depending on which terminals the voltage is measured across.

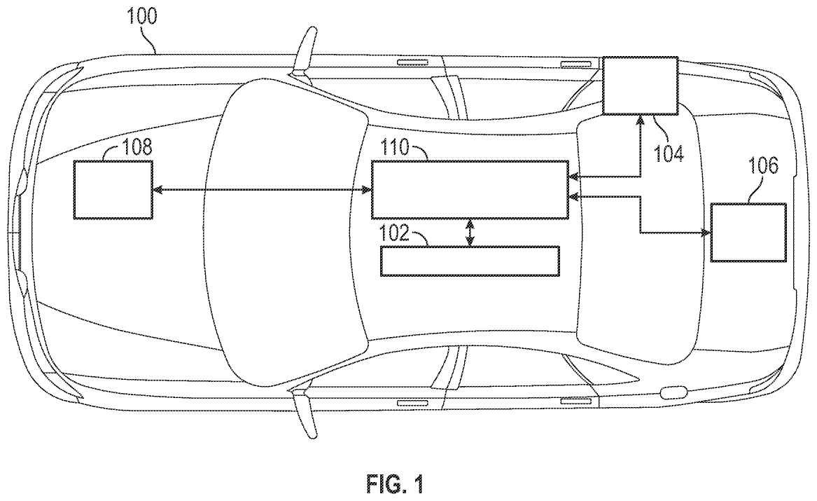

Referring now to FIG. 1, a schematic diagram of an electric vehicle 100 according to one or more embodiments is shown. As illustrated, the electric vehicle 100 includes a high-voltage battery 106 that is connected to an electrical distribution system 110, which includes one or more onboard electrical outlets (not shown). In exemplary embodiments, the high-voltage battery 106 has a voltage in excess of four hundred volts. In exemplary embodiments, the electrical distribution system 110 includes at least one onboard charging module that includes a bi-directional alternating current (AC) to direct current (DC) converter. The electrical distribution system 110 is connected to an electric motor 108 that is configured to provide propulsion to the electric vehicle 100 by drawing power from the high-voltage battery 106. The electrical distribution system 110 is also connected to a charge port 104 that is configured to receive AC power that is used by the electrical distribution system 110 to charge the high-voltage battery 106. The electric vehicle 100 also includes a controller 102, which is one of a general-purpose processor, a Field Programmable Gate Array (FPGA), an Application-Specific Integrated Circuit (ASIC), and the like. The controller 102 is configured to control the operation of one or more of the electric motor 108 and the electrical distribution system 110.

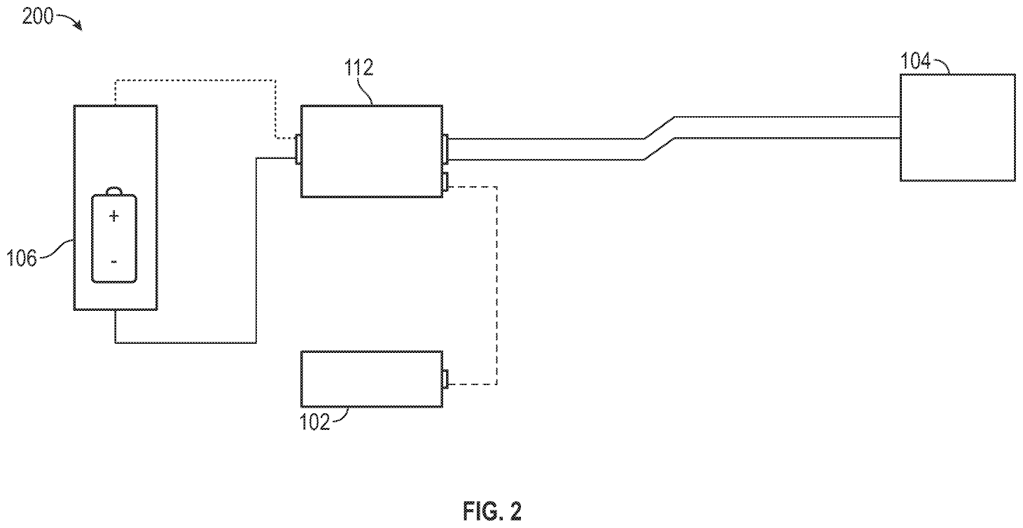

Referring now to FIG. 2, a block diagram illustrating a portion of an electrical system 200 of a traditional electric vehicle is shown. As illustrated, the electrical system 200 of a traditional electric vehicle includes a high-voltage battery 106 that is connected to a charge port via a primary onboard charging module 112. The primary onboard charging module 112 is configured to receive alternating current power from the charge port 104 and to convert the alternating current power to direct current power that is used to charge the high-voltage battery 106. In exemplary embodiments, the electrical system 200 also includes a controller 102 that is configured to control the operation of the primary onboard charging module 112.

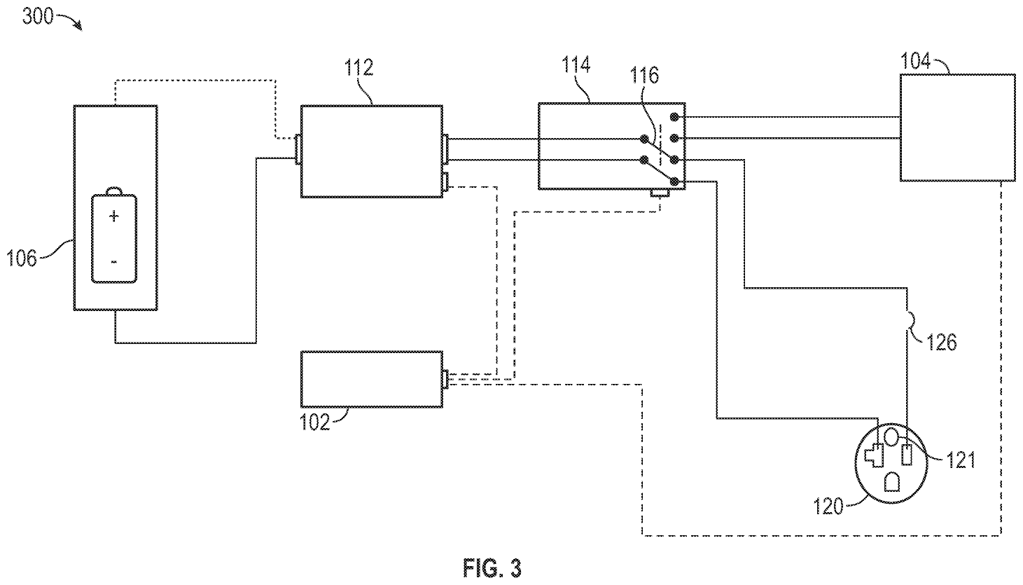

Referring now to FIG. 3, a block diagram illustrating a portion of an electrical system 300 of an electric vehicle in accordance with an exemplary embodiment is shown. As illustrated, the electrical system 300 of the electric vehicle includes a high-voltage battery 106 that is connected to a primary onboard charging module 112. In exemplary embodiments, the primary onboard charging module 112 includes a bi-directional AC to DC converter. The electrical system 300 of the electric vehicle also includes a charge port 104 that is configured to receive alternating current power.

In exemplary embodiments, the electrical system 300 of the electric vehicle also includes a diverter 114 that is configured to selectively connect the primary onboard charging module 112 to one of the charge port 104 and an onboard electrical outlet 120. In exemplary embodiments, the onboard electrical outlet 120 is a one-hundred-and-twenty-volt alternating current outlet. The electrical system 300 of the electric vehicle also includes a controller 102 that is configured to control the operation of the primary onboard charging module 112 and the diverter 114. For example, the controller 102 may be configured to control the position of one or more switches 116 of the diverter based on an operational mode of the primary onboard charging module 112 and/or based on whether the charge port 104 is connected to an external power source. Although illustrated as being separate devices, those of ordinary skill in the art will appreciate that the diverter 114 may be included as part of the primary onboard charging module 112.

In one embodiment, the controller 102 is configured to determine that AC power is being supplied from the charge port 104 and responsively configures the switches 116 of the diverter 114 to electrically connect the charge port 104 to the primary onboard charging module 112 to charge the high-voltage battery 106. Likewise, when the controller 102 determines that AC power is not being supplied from the charge port 104, the controller 102 configures the switches 116 of the diverter 114 to electrically connect the onboard electrical outlet 120 to the primary onboard charging module 112 to provide AC power to the onboard electrical outlet 120.

In exemplary embodiments, the electrical system 300 of the electric vehicle also includes a circuit breaker 126 disposed between the diverter 114 and the onboard electrical outlet 120. In exemplary embodiments, the circuit breaker 126 may be manually or electronically controlled and is configured to restrict the level of current drawn by the onboard electrical outlet 120. In exemplary embodiments, the onboard electrical outlet 120 includes an indicator light 121 that is configured to illuminate when the onboard electrical outlet 120 is energized. In addition, the indicator light 121 may be configured to indicate if there is an issue (fault), if the system is close to being overloaded, etc.

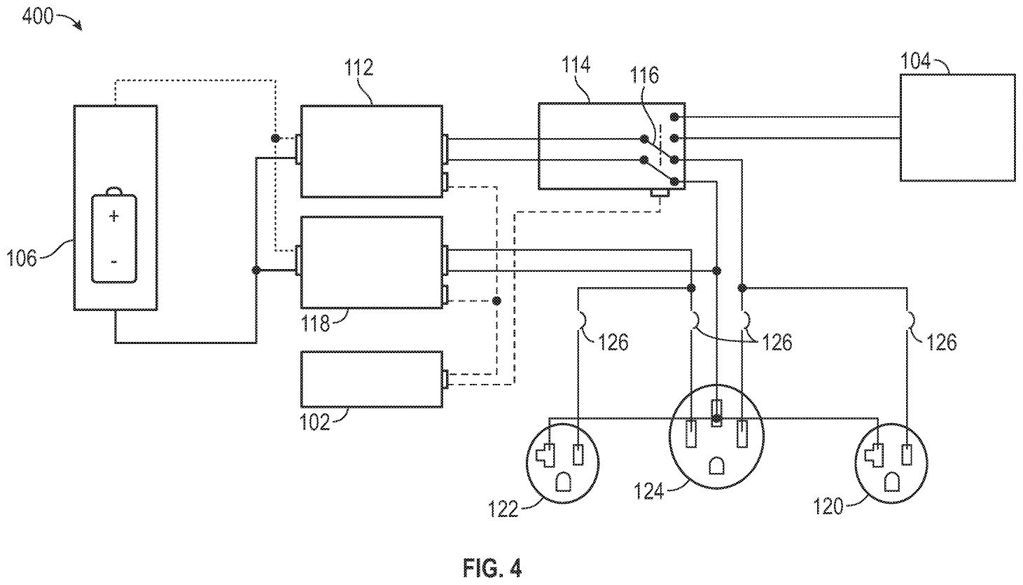

Referring now to FIG. 4, a block diagram illustrating a portion of an electrical system 400 of an electric vehicle in accordance with an exemplary embodiment is shown. As illustrated, the electrical system 400 of the electric vehicle includes a high-voltage battery 106 that is connected to a primary onboard charging module 112 and to a secondary onboard charging module 118. In one embodiment, the primary onboard charging module 112 and the secondary onboard charging module 118 include a bi-directional AC to DC converter. In another embodiment, the primary onboard charging module 112 includes a bi-directional AC to DC converter and the secondary onboard charging module 118 includes a unidirectional DC to AC converter. The electrical system 400 of the electric vehicle also includes a charge port 104 that is configured to receive alternating current power.

In exemplary embodiments, the electrical system 400 of the electric vehicle also includes a diverter 114 that is configured to selectively connect the primary onboard charging module 112 to either the charge port 104 or an onboard electrical outlet 120 and a split-phase onboard electrical outlet 124. The electrical system 400 of the electric vehicle also includes a controller 102 that is configured to control the operation of one or more of the primary onboard charging module 112, the secondary onboard charging module 118, and the diverter 114. For example, the controller 102 may be configured to control the position of one or more switches 116 of the diverter based on an operational mode of the primary onboard charging module 112 and/or based on whether the charge port 104 is connected to an external power source.

In exemplary embodiments, the electrical system 400 of the electric vehicle includes onboard electrical outlet 120, a second onboard electrical outlet 122, and split-phase onboard electrical outlet 124. In exemplary embodiments, the output voltage of the split-phase onboard electrical outlet 124 is approximately twice the output voltage of the onboard electrical outlet 120 and the second onboard electrical outlet 122. In exemplary embodiments, the onboard electrical outlet 120, the second onboard electrical outlet 122, and split-phase onboard electrical outlet 124 each include an indicator light that is configured to illuminate when the electrical outlets are energized.

In exemplary embodiments, the secondary onboard charging module 118 is configured to generate an AC output that is one hundred and eighty degrees out of phase with the AC output of the primary onboard charging module 112. In exemplary embodiments, the split-phase onboard electrical outlet 124 includes a first terminal that is connected to the output of the primary onboard charging module 112 and a second terminal that is connected to the output of the secondary onboard charging module 118.

In exemplary embodiments, the electrical system 400 of the electric vehicle also includes circuit breakers 126 that are connected in series with the onboard electrical outlet 120, the second onboard electrical outlet 122, and the split-phase onboard electrical outlet 124. In exemplary embodiments, the circuit breakers 126 may be manually or electronically controlled and are configured to restrict the level of current drawn by the onboard electrical outlet 120, the second onboard electrical outlet 122, and the split-phase onboard electrical outlet 124.

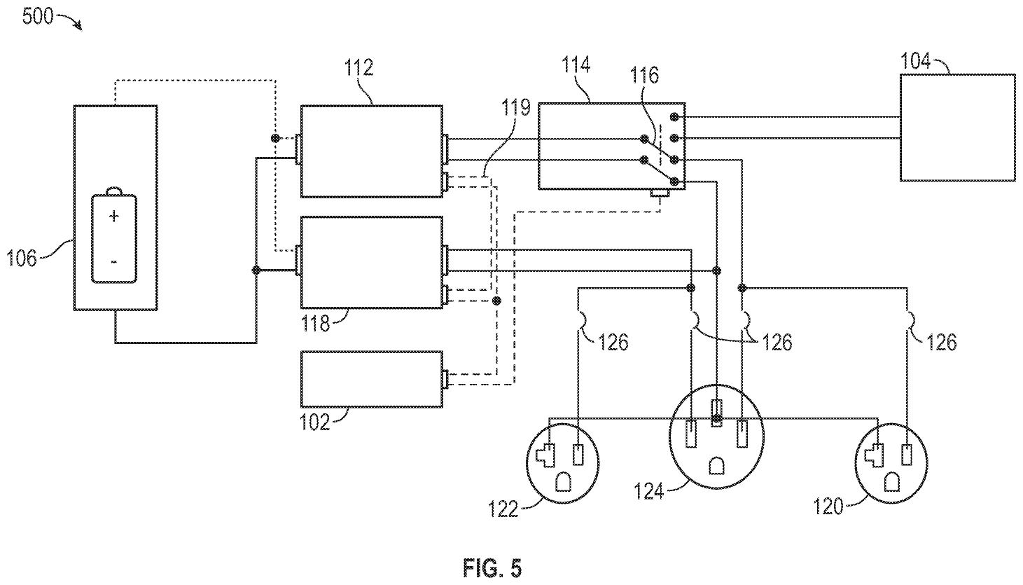

Referring now to FIG. 5, a block diagram illustrating a portion of an electrical system 500 of an electric vehicle in accordance with an exemplary embodiment is shown. The electrical system 500 includes the same elements as the electrical system 400 shown in FIG. 4, to the extent that the functionality of these elements is the same, the description of these elements will not be repeated for the sake of brevity.

In exemplary embodiments, the primary onboard charging module 112 is configured to communicate directly with the secondary onboard charging module 118 via connection 119. In exemplary embodiments, the secondary onboard charging module 118 is configured to monitor a phase of the AC output of the primary onboard charging module 112 and to generate an AC output that is one hundred and eighty degrees out of phase with the AC output of the primary onboard charging module 112. In this embodiment where the primary onboard charging module 112 is configured to communicate directly with the secondary onboard charging module 118 via connection 119, there are multiple ways the output of the secondary onboard charging module 118 can be one hundred and eighty degrees out of phase from the output of the primary onboard charging module 112. In one embodiment, the primary onboard charging module 112 and the secondary onboard charging module 118 share a common clock and/or their control is synchronized, and the onboard charging modules each know how to output the AC voltage based on the timing of the shared/synchronized clock. In another embodiment, the primary onboard charging module 112 provides direct control to the secondary onboard charging module 118. i.e., the primary onboard charging module 112 tells the secondary onboard charging module 118 what to do.

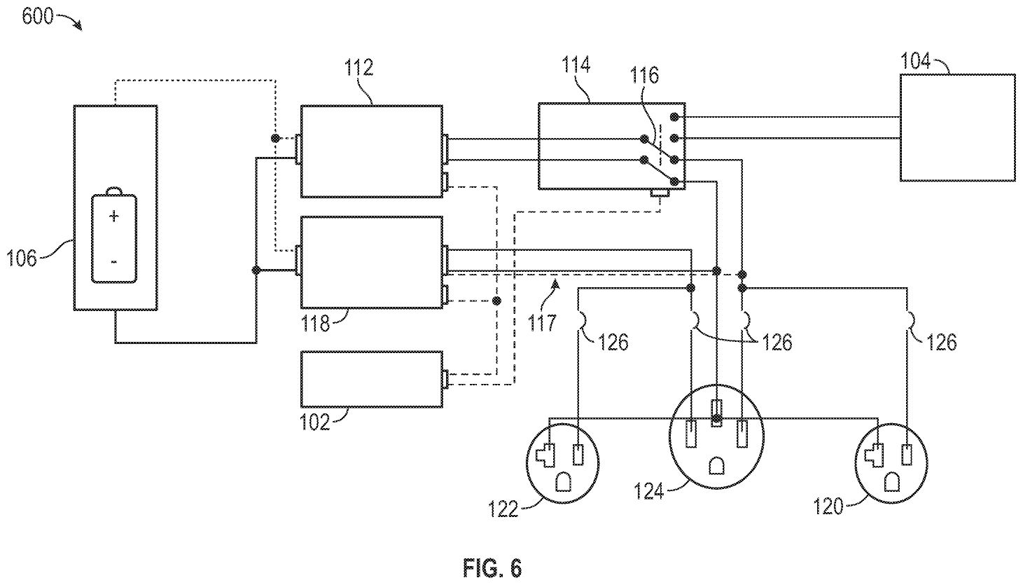

Referring now to FIG. 6, a block diagram illustrating a portion of an electrical system 600 of an electric vehicle in accordance with an exemplary embodiment is shown. The electrical system 600 includes the same elements as the electrical system 400 in FIG. 4, to the extent that the functionality of these elements is the same, the description of these elements will not be repeated for the sake of brevity.

In exemplary embodiments, the secondary onboard charging module 118 is configured to monitor the electrical connection between the diverter 114 and the onboard electrical outlet 120 via connection 117. In exemplary embodiments, the secondary onboard charging module 118 is configured to monitor a phase of the AC power provided to the onboard electrical outlet 120 and to independently generate an AC output that is one hundred and eighty degrees out of phase with the AC provided to the onboard electrical outlet 120.

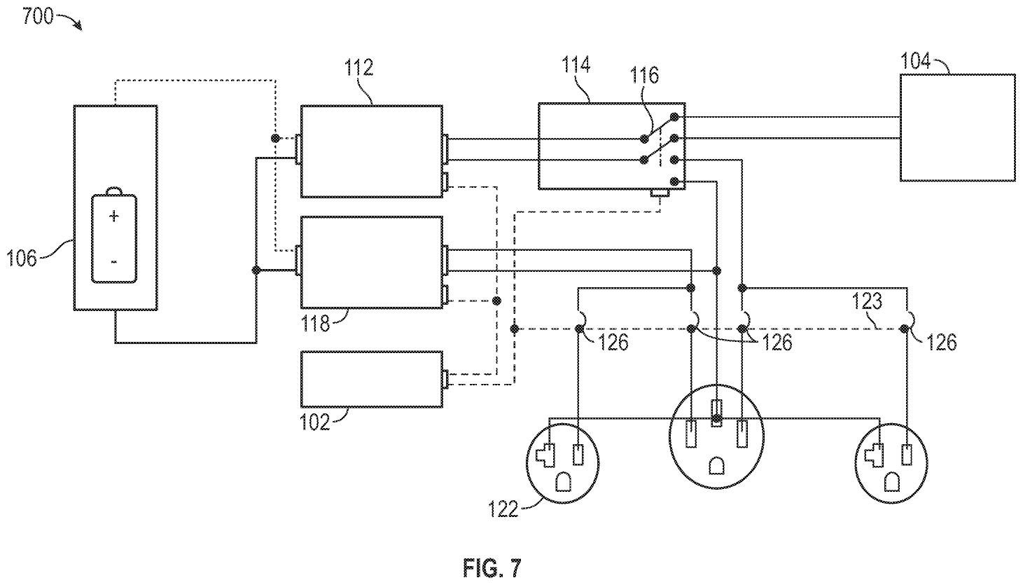

Referring now to FIG. 7, a block diagram illustrating a portion of an electrical system 700 of an electric vehicle in accordance with an exemplary embodiment is shown. The electrical system 700 includes the same elements as the electrical system 400 in FIG. 4, to the extent that the functionality of these elements is the same, the description of these elements will not be repeated for the sake of brevity.

In exemplary embodiments, the electrical system 700 includes a plurality of circuit breakers 126 that are electronically controlled by the controller 102 via communications link 123. In exemplary embodiments, the controller 102 is configured to open the circuit breaker 126 disposed between the diverter 114 and the split-phase onboard electrical outlet 124, and the circuit breaker 126 disposed between the diverter 114 and the onboard electrical outlet 120 based on a determination that AC power is being received from the charge port 104 by the diverter 114. In addition, the controller 102 may be configured to electronically reset any of the circuit breakers 126 after a trip or excess current event is detected.

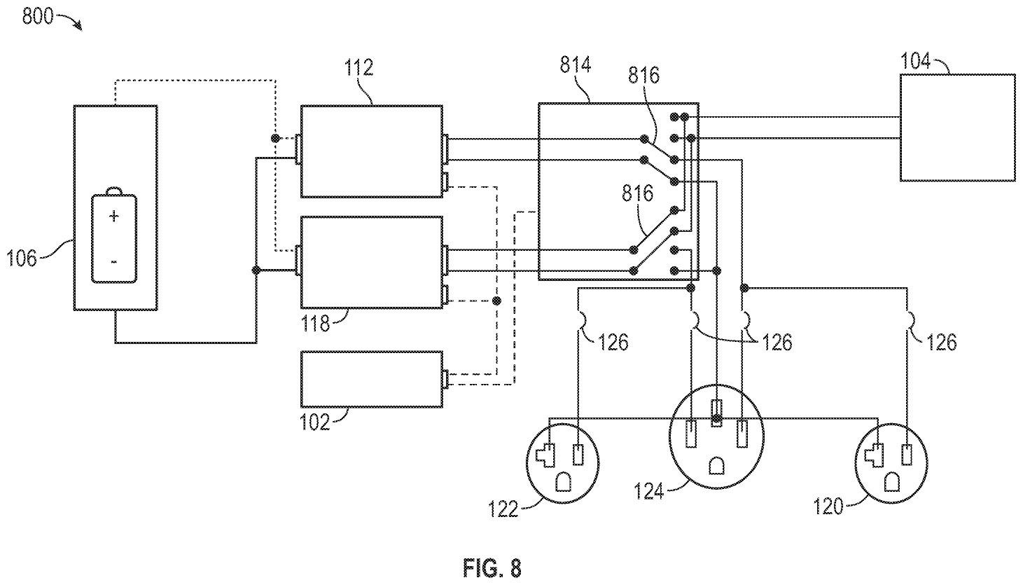

Referring now to FIG. 8, a block diagram illustrating a portion of an electrical system 800 of an electric vehicle in accordance with an exemplary embodiment is shown. The electrical system 800 includes the same elements as the electrical system 400 in FIG. 4, to the extent that the functionality of these elements is the same, the description of these elements will not be repeated for the sake of brevity.

In exemplary embodiments, the electrical system 800 includes a diverter 814 that is configured to utilize switches 816 to selectively connect the charge port 104 to one of the primary onboard charging module 112, the secondary onboard charging module 118, the onboard electrical outlet 120, the second onboard electrical outlet 122, and the split-phase onboard electrical outlet 124. In exemplary embodiments, both the primary onboard charging module 112 and the secondary onboard charging module 118 include bi-directional AC to DC converters that are configured to convert AC current received from the charge port to DC current for charging the high-voltage battery 106. In exemplary embodiments, the secondary onboard charging module 118 is configured to act as back up to the primary onboard charging module 112 and can be used to charge the high-voltage battery 106 if the primary onboard charging module 112 fails. In one embodiment, the secondary onboard charging module 118 can also be used to increase the AC charging power. e.g., each OBCM is rated for 11 kW and combined they can draw the 19.2 kW maximum allowed by the charging standards, assuming the external AC charger is capable.

In exemplary embodiments, the controller 102 is configured to selectively control the operation of the switches 816 based on whether the electric vehicle is charging and based on an operational mode of the primary onboard charging module 112 and the secondary onboard charging module 118.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An electric vehicle comprising:
a charge port;
an onboard electrical outlet;
a high-voltage battery;
a primary onboard charging module electrically connected to the high-voltage battery;
a diverter configured to selectively connect the primary onboard charging module to one of the onboard electrical outlet and the charge port; and
a controller configured to control an operation of the diverter,
wherein the primary onboard charging module includes a bidirectional alternating current (AC) to direct current (DC) converter.

2. The electric vehicle of claim 1, further comprising:
a secondary onboard charging module electrically connected to the high-voltage battery; and
a split-phase onboard electrical outlet electrically connected to the secondary onboard charging module and the diverter;
wherein the secondary onboard charging module includes a DC to AC converter.

3. The electric vehicle of claim 2, wherein the onboard electrical outlet is electrically connected to the split-phase onboard electrical outlet.

4. The electric vehicle of claim 2, wherein the split-phase onboard electrical outlet has an output voltage that is twice the output voltage of the onboard electrical outlet.

5. The electric vehicle of claim 2, wherein an AC output of the secondary onboard charging module is configured to be one hundred and eighty degrees out of phase with an AC output of the primary onboard charging module.

6. The electric vehicle of claim 2, wherein the controller is further configured to control an operation of the primary onboard charging module and the secondary onboard charging module.

7. The electric vehicle of claim 1, further comprising a circuit breaker disposed between the diverter and the onboard electrical outlet.

8. An electric vehicle comprising:
a charge port;
an onboard electrical outlet;
a split-phase onboard electrical outlet;
a high-voltage battery;
a primary onboard charging module electrically connected to the high-voltage battery;
a secondary onboard charging module electrically connected to the high-voltage battery and to the split-phase onboard electrical outlet;
a diverter electrically connected to the primary onboard charging module, the diverter configured to selectively connect the primary onboard charging module to the charge port or to the onboard electrical outlet and the split-phase onboard electrical outlet; and
a controller configured to control an operation of the diverter,
wherein the primary onboard charging module and the secondary onboard charging module each include a bidirectional alternating current (AC) to direct current (DC) converter.

9. The electric vehicle of claim 8, wherein the split-phase onboard electrical outlet has an output voltage that is twice the output voltage of the onboard electrical outlet.

10. The electric vehicle of claim 8, wherein an AC output of the secondary onboard charging module is configured to be one hundred and eighty degrees out of phase with an AC output of the primary onboard charging module.

11. The electric vehicle of claim 8, wherein the controller is further configured to control an operation of the primary onboard charging module and the secondary onboard charging module.

12. The electric vehicle of claim 8, further comprising circuit breakers disposed between:
the diverter and the onboard electrical outlet;
the diverter and the split-phase onboard electrical outlet;
the secondary onboard charging module and the onboard electrical outlet; and
the secondary onboard charging module and the split-phase onboard electrical outlet.

13. The electric vehicle of claim 12, wherein the circuit breakers are electronically controlled circuit breakers that are operated by the controller.

14. The electric vehicle of claim 8, wherein the primary onboard charging module is configured to communicate directly with the secondary onboard charging module.

15. The electric vehicle of claim 12, wherein the onboard electrical outlet and the split-phase onboard electrical outlet include an indicator light that indicates whether the onboard electrical outlet and the split-phase onboard electrical outlet are energized.

16. The electric vehicle of claim 12, wherein the diverter is further configured to selectively connect the charge port to the secondary onboard charging module.

17. An electric vehicle comprising:
a charge port;
a first onboard electrical outlet;
a second onboard electrical outlet;
a split-phase onboard electrical outlet;
a high-voltage battery;
a primary onboard charging module electrically connected to the high-voltage battery;
a secondary onboard charging module electrically connected to the high-voltage battery, to the second onboard electrical outlet, and to the split-phase onboard electrical outlet;
a diverter electrically connected to the primary onboard charging module, the diverter configured to selectively connect the primary onboard charging module to the charge port or to the first onboard electrical outlet and the split-phase onboard electrical outlet; and
a controller configured to control an operation of the diverter,
wherein the primary onboard charging module and the secondary onboard charging module each include a bidirectional alternating current (AC) to direct current (DC) converter.

18. The electric vehicle of claim 17, wherein the split-phase onboard electrical outlet has an output voltage that is twice the output voltage of the first onboard electrical outlet and the second onboard electrical outlet.

19. The electric vehicle of claim 17, wherein an AC output of the secondary onboard charging module is configured to be one hundred and eighty degrees out of phase with an AC output of the primary onboard charging module.

20. The electric vehicle of claim 17, wherein the controller is further configured to control an operation of the primary onboard charging module and the secondary onboard charging module.
